(19) United States
(12) Patent Application Publication
(10) Pub. No.: US 2010/0099534 A1
(43) Pub. Date: Apr. 22, 2010

(54) TRANSMISSION MECHANISM

(75) Inventors: Masayoshi Muraki, Yokohama-shi (JP); Kikuo Okamura, Kyoto-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignees: SHONAN INSTITUTE OF TECHNOLOGY, Fujisawa-shi, Kanagawa (JP); CAMPUS CREATE CO., LTD., Setagaya-ku, Tokyo (JP)

(21) Appl. No.: 12/514,981

(22) PCT Filed: Nov. 13, 2007
(86) PCT No.: PCT/JP2007/071950

§ 371 Date: Nov. 16, 2009

(30) Foreign Application Priority Data
Nov. 16, 2006 (JP) 2006-309793

(51) Int. Cl. F16H 15/50

(52) U.S. Cl. 475/185

(57) ABSTRACT

The present invention provides a transmission unit that can realize a high speed-shifting ratio, can realize reduced size, low cost and low noise, and is also capable of limiting slip loss. Outer peripheral surfaces of a small diameter rolling element and a supplementary rolling element are brought into contact with an outer peripheral surface of a large diameter rolling element. The supplementary rolling element is arranged at an almost opposite side to the small diameter rolling element, thus enclosing the large diameter rolling element between the small diameter rolling element and the supplementary rolling element. An inner peripheral surface of the pressure adjustment ring is brought into contact with the outer peripheral surface of the small diameter rolling element and the outer peripheral surface of the supplementary rolling element, and is supported by them. If the small diameter rolling element rotates, the pressure adjustment ring rotates by means of the large diameter rolling element and the supplementary rolling element. If load is applied to rotation of the large diameter rolling element, the pressure adjustment ring is made eccentric. In this way, the small diameter rolling element receives pressing force toward an inner side in the radial direction of the large diameter rolling element, from the pressure adjustment ring.

### TECHNICAL FIELD

The present invention relates to a transmission mechanism used mainly in transmission of power.

### BACKGROUND ART

Examples of transmission mechanisms are disclosed in the following publications, patent publications 1 to 6, for example. Transmission in the context of this specification collectively means both gearing up and gearing down.

The technology disclosed in these publications can be those using toothed gears (patent publication 3, for example) and those using rollers (for example, patent publication 4).

In a transmission mechanism using toothed gears, there are the drawbacks such as:

in order to obtain a high reduction ratio, it is necessary to combine a lot of gears, which means there is a tendency for the mechanism to become large in size

if a lot of gears are used, the weight and noise are increased.

Also, in transmission mechanisms using rollers there are drawbacks such as:

in the case of high load, it is easy for slippage (slip loss) to arise between a drive roller and a driven roller

if a biasing mechanism for limiting slippage is provided, the mechanism becomes complicated

Patent publication 1:

Japanese examined patent publication No. Hei. 6-74831

### Patent Publication 2:

Japanese unexamined patent Publication No. 2002-31202.

### Patent Publication 3:

Japanese unexamined patent publication No. Hei. 8-294515

### Patent Publication 4:

Japanese unexamined patent publication N. 2006-117003

### Patent Publication 5

Japanese Examined Utility Model publication No. Sho. 33-4426

### DISCLOSURE OF THE INVENTION

The present invention has been conceived in view of the above described situation. The present invention is directed to providing a transmission unit that can realize a high transmission gear ratio, can realize reduced size, low cost, and low noise, and is also capable of limiting slip loss.

A transmission unit of this invention is provided with a small diameter rolling element, a large diameter rolling element, a supplementary rolling element, and a pressure adjustment ring. The small diameter rolling element is capable of rotation with a first virtual axis of rotation as a center. Also, an outer peripheral surface of the small diameter rolling element is brought into contact with an outer peripheral surface of the large diameter rolling element.

The large diameter rolling element is capable of rotation with a second virtual axis of rotation as a center. Also, the second virtual axis of rotation of the large diameter rolling element is arranged so as to be substantially parallel to the first virtual axis of rotation of the small diameter rolling element.

The supplementary rolling element is capable of rotation with a third virtual axis of rotation as a center. Also, an outer peripheral surface of the supplementary rolling element is brought into contact with an outer peripheral surface of the large diameter rolling element. Further, the third virtual axis of rotation of the supplementary rolling element is arranged so as to be substantially parallel to the first virtual axis of rotation of the small diameter rolling element. Also, the supplementary rolling element is arranged at a position sandwiching the large diameter rolling element together with the small diameter rolling element.

The pressure adjustment ring is arranged so as to surround the small diameter rolling element, the large diameter rolling element and the supplementary rolling element. The pressure adjustment ring is also capable of rotation with a fourth virtual axis of rotation as a center. Further, the fourth virtual axis of rotation of the pressure adjustment ring is arranged so as to be substantially parallel to the second virtual axis of rotation of the large diameter rolling element. Also, an inner peripheral surface of the pressure adjustment ring is brought into contact with the outer peripheral surface of the small diameter rolling element and the outer peripheral surface of the supplementary rolling element.

According to this invention, it becomes possible to perform speed-shifting between the small diameter rolling element and the large diameter rolling element whose outer peripheral surfaces are brought into contact with each other. Accordingly, by connecting the small diameter rolling element to a high speed shaft side, and connecting the large diameter rolling element to a low speed shaft side, it becomes possible to vary speed between the high speed shaft and the low speed shaft.

It is possible for the small diameter rolling element of the present invention to be capable of movement in a radial direction of the large diameter rolling element.

It is possible for the supplementary rolling element of the present invention to be capable of movement in a radial direction of the large diameter rolling element.

It is possible for the pressure adjustment ring of the present invention to be supported by the small diameter rolling element and the supplementary rolling element.

It is possible for the first to third virtual axes of rotation of the present invention to be arranged on a single plane.

In the present invention, it is possible to arrange the first and second virtual axes of rotation on a first plane, and arrange the second and third virtual axes of rotation on a second plane, and to make an external angle θ defined between the first plane and the second plane to satisfy 0<θ<180°.

The transmission unit of the present invention can be further provided with a speed reduction mechanism. This speed reduction mechanism can be arranged at an inner side of the large diameter rolling element. It is also possible for the speed reduction mechanism to have a structure that reduces speed derived from rotational force applied to the large diameter rolling element as a result of being connected to the large diameter rolling element.

It is possible for the small diameter rolling element of the present invention to be capable of connection to a drive source for driving the small diameter rolling element in a direction in which the small diameter rolling element rotates.

A wheel drive unit of the present invention is provided with any of the transmission units described above, an axle, and an axle support section. The axle support section is capable of rotation with respect to the axle. Also, the axle support section is connected to the large diameter rolling element, and rotates in accordance with rotation of the large diameter rolling element.

A power transmission of the present invention is provided with any of the transmission units described above, and an output shaft. Also, the output shaft is connected to the large diameter rolling element, and rotates in accordance with rotation of the large diameter rolling element.

With the transmission unit of the present invention, it is possible to have a configuration of the outer peripheral surface of the small diameter rolling element and the outer peripheral surface of the large diameter rolling element whereby rotational force of one rolling element is transmitted to another rolling element, as a result of using a shear force, of an oil film under high pressure using traction oil or traction grease interposed between the two rolling elements, as a frictional force.

According to the present invention, by using a small diameter rolling element and a large diameter rolling element, it is possible to realize a high speed-varying ratio, and it becomes possible to achieve small size, low cost and low noise. Also, by using a supplementary rolling element and a pressure adjustment ring, it is possible to suppress slip loss between the small diameter rolling element and the large diameter rolling element.

### BRIEF DESCRIPTION OF THE DRAWINGS

FIG. 1 is a cross sectional drawing of a wheel driving unit of a first embodiment of the present invention.

FIG. 2 is a drawing looking towards arrowed lines A-A in the device shown in FIG. 1.

FIG. 3 is a drawing equivalent to FIG. 2, and is an explanatory drawing for describing operation of a transmission unit.

FIG. 4 is an explanatory drawing showing a transmission unit of a second embodiment of the present invention, and is equivalent to FIG. 2.

FIG. 5 is a cross sectional drawing of a power transmission unit of a third embodiment of the present invention.

FIG. 6 is a drawing looking towards arrowed lines C-C in the device shown in FIG. 5.

FIG. 7 is a cross sectional drawing of a power transmission unit of a fourth embodiment of the present invention.

FIG. 8 is a drawing looking towards arrowed lines C-C in the device shown in FIG. 5.

### BEST MODE FOR CARRYING OUT THE INVENTION

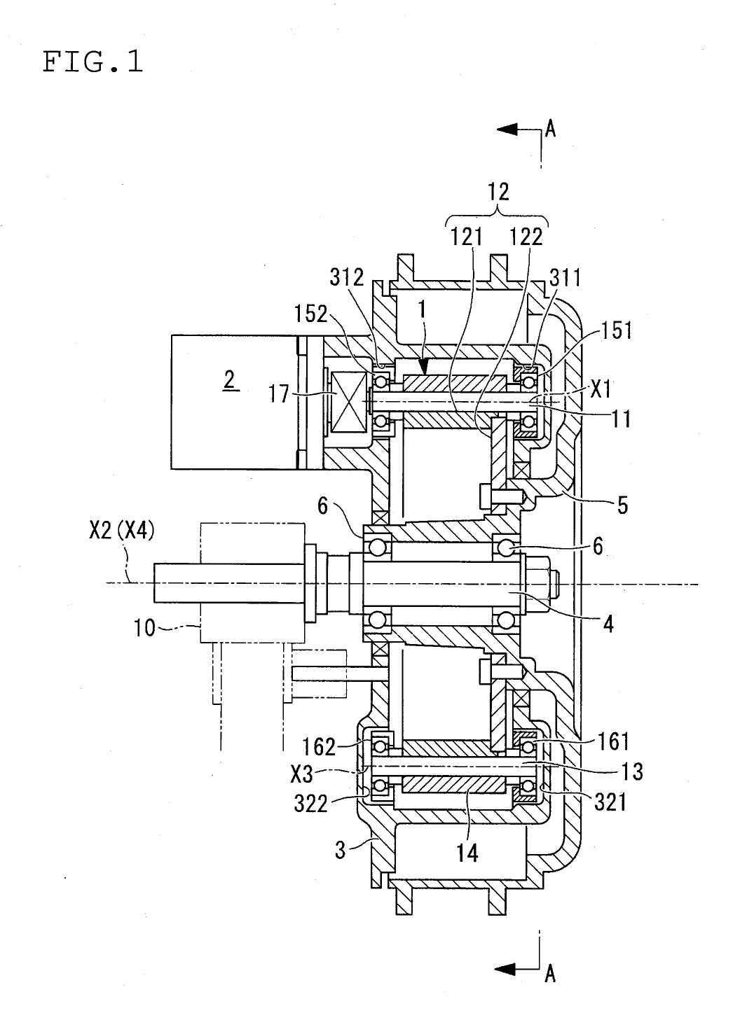

A first embodiment of a transmission unit of the present invention, and a wheel drive unit using the transmission unit, will be described with reference to FIG. 1 to FIG. 3.

### Structure of First Embodiment

The wheel drive unit of this embodiment comprises a transmission unit 1, drive source 2, support body 3, axle 4, hub (axle support section) 5 and bearing 6 as main components.

### Structure of Transmission Unit of this Embodiment

A transmission unit 1 is provided with a small diameter rolling element 11, a large diameter rolling element 12, a supplementary rolling element 13, and a pressure adjustment ring 14, as main components.

The small diameter rolling element 11 is capable of rotation with a first virtual axis of rotation X1 as a center. In more detail, both end sections of the small diameter rolling element 11 are supported by bearings 151 and 152 (refer to FIG. 1), and the small diameter rolling element 11 is thus rotatable about the axis.

Also, one end of the small diameter rolling element 11 is connected by means of a universal joint 17 to the drive source 2. In this way the small diameter rolling element 11 is connected to the drive source for driving the small diameter rolling element 11 in the direction in which the small diameter rolling element 11 rotates.

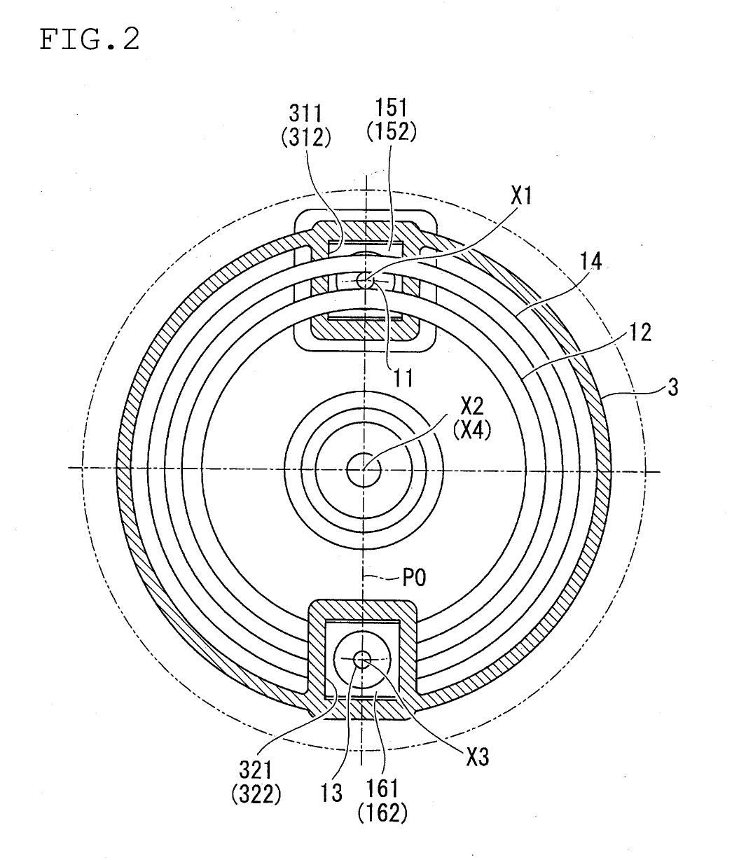

Further, the outer peripheral surface of the small diameter rolling element 11 is brought into contact with the outer peripheral surface of the large diameter rolling element 12 (refer to FIG. 1 and FIG. 2). The outer peripheral surface of the small diameter rolling element 11 is a cylindrical shape parallel to the first virtual axis of rotation X1.

The bearings 151 and 152 for supporting the small diameter rolling element 11 are contained in slits 311 and 312 formed in the support body 3. In a state where the bearings 151 and 152 are housed in the slits 311 and 312, they are capable of movement in the radial direction of the large diameter rolling element 12 (vertical direction in FIG. 1 and FIG. 2). This can be realized by providing a gap between each of the slits and each of the bearings, and making each of the bearings capable of movement in the range of that gap. With this structure, it becomes possible for the small diameter rolling element 11 to move in the radial direction of the large diameter rolling element 12.

The large diameter rolling element 12 is comprised of an outer peripheral section 121 constituting the outer periphery of the large diameter rolling element 12, and a transmission section 122 fixed to this outer peripheral section 121.

The large diameter rolling element 12 is capable of rotation with a second virtual axis of rotation X2 as a center. More specifically, the large diameter rolling element 12 is rotatably attached to the axle 4 via the hub 5 and bearing 6, and is thus capable of rotation.

Also, the second virtual axis of rotation X2 of the large diameter rolling element 12 is arranged so as to be substantially parallel to the first virtual axis of rotation X1 of the small diameter rolling element 11. The outer peripheral surface of the large diameter rolling element 12 is a cylindrical shape parallel to the second virtual axis of rotation X2. That is, the outer peripheral surface (cylindrical surface) of the large diameter rolling element 12 is also parallel to the first virtual axis of rotation X1 of the small diameter rolling element 11.

Also, a ratio of the diameter of the large diameter rolling element 12 and the diameter of the small diameter rolling element 11 can be set arbitrarily, but can be set at between about 2-50:1, for example.

The transmission section 122 of the large diameter rolling element 12 is fixed to the hub 5 using bolts. In this way, if the outer peripheral section 121 of the large diameter rolling element 12 turns, then the hub 5 also rotates.

The supplementary rolling element 13 is capable of rotation with a third virtual axis of rotation X3 as a center. In more detail, both end sections of the supplementary rolling element 13 are supported by bearings 161 and 162 (refer to FIG. 1), and the supplementary rolling element 13 is thus rotatable about the shaft.

Also, an outer peripheral surface of the supplementary rolling element 13 is brought into contact with an outer peripheral surface of the large diameter rolling element 12.

Further, the third virtual axis of rotation X3 of the supplementary rolling element 13 is arranged so as to be substantially parallel to the first virtual axis of rotation X1 of the small diameter rolling element 11.

The supplementary rolling element 13 is also arranged at a position at an opposite side to the small diameter rolling element 11, thus enclosing the large diameter rolling element 12 between the small diameter rolling element 11 and the supplementary rolling element 13. Specifically, the virtual axis of rotation X3 of the supplementary rolling element 13, the virtual axis of rotation X2 of the large diameter rolling element 12, and the virtual axis of rotation X1 of the small diameter rolling element 11 are all arranged on a single virtual plane P0 (refer to FIG. 2). That is, the supplementary rolling element 13 sandwiches the large diameter rolling element 12, between itself and the small diameter rolling element 11. However, in this specification, as will be described later, it is also possible for the position of the supplementary rolling element 13 to be not exactly at the opposite side of the small diameter rolling element 11. Accordingly, in this specification the phrase “position sandwiching the large diameter rolling element 12” does not only mean a position exactly at the opposite side, but can also be taken to mean a broad positional relationship where the large diameter rolling element 12 is between the two members.

Also, the bearings 161 and 162 for supporting the supplementary rolling element 13 are contained in slits 321 and 322 formed in the support body 3. In a state where the bearings 161 and 162 are housed in the slits 321 and 322, they are capable of movement in the radial direction of the large diameter rolling element 12 (vertical direction in FIG. 1 and FIG. 2). This can be realized, in the same was as for the case of the small diameter rolling element 11, by providing a gap between each of the slits and each of the bearings, and making each of the bearings capable of movement in the range of that gap. With this structure, it becomes possible for the supplementary rolling element 13 to move in the radial direction of the large diameter rolling element 12.

The pressure adjustment ring 14 is arranged so as to surround the small diameter rolling element 11, the large diameter rolling element 12 and the supplementary rolling element 13 (refer to FIG. 1 and FIG. 2). That is, the pressure adjustment ring 14 has a larger diameter than the large diameter rolling element 12, and the small diameter rolling element 11, large diameter rolling element 12 and supplementary rolling element 13 are contained inside the pressure adjustment ring 14. Here, if the inner diameter of the pressure adjustment ring 14 is made N, the outer diameter of the small diameter rolling element 11 is made n1, the outer diameter of the large diameter rolling element 12 is made n2, the outer diameter of the supplementary rolling element 13 is made n3 and the dimensional tolerance is made d, then the following relationship is established.

N=n1+n2+n3+d

What the value of d is set to is determined by taking into account elements such as machining, assembly, a rotational resistance etc. Generally, if the value of d is small, the rotational resistance because of rotation of the pressure adjustment ring 14 tends to become large, while if the value of d is large it tends to be become difficult for a pressure adjustment operation (described later) by the pressure adjustment ring 14 to take place.

The pressure adjustment ring 14 is also capable of rotation with a fourth virtual axis of rotation X4 as a center. In more detail, the pressure adjustment ring 14 in this embodiment is constructed being supported by the small diameter rolling element 11 and the supplementary rolling element 13. Therefore, the pressure adjustment ring 14 is configured capable of rotating with rotation of the small diameter rolling element 11 and the supplementary rolling element 13.

Further, the fourth virtual axis of rotation X4 of the pressure adjustment ring 14 is arranged so as to be substantially parallel to the second virtual axis of rotation X2 of the large diameter rolling element 12. Also, this fourth virtual axis of rotation X4 is arranged at a position that is effectively the same as that of the second virtual axis of rotation X2 in this embodiment. However, as will be described later, the pressure adjustment ring 14 is capable of flexing or being made eccentric, which means that the position of the fourth virtual axis of rotation X4 is offset from the position of the axis X2 by just that amount (with FIG. 1, the same position is shown for both).

Also, an inner peripheral surface of the pressure adjustment ring 14 is brought into contact with the outer peripheral surface of the small diameter rolling element 11 and the outer peripheral surface of the supplementary rolling element 13. Specifically, as described previously, the pressure adjustment ring 14 in this embodiment is constructed being supported by the small diameter rolling element 11 and the supplementary rolling element 13.

### (Structure of a Wheel Drive Unit)

As the drive source 2, in this embodiment an electric motor is used. It is possible, however, to use another type of motor as the drive source 2 (for example, an internal combustion engine). Basically, anything can be used as the drive source 2 as long as it produces rotational output.

The drive source 2 is fixed to the support body 3 using bolts. An output shaft of the drive source 2 is connected to the small diameter rolling element 11 by means of a universal joint 17. As a result, using rotational force from the drive source 2 it is possible to cause rotation of the small diameter rolling element 11.

The support body 3 is a section constituting the body section of the wheel drive unit, and supports the main components of the unit.

The axle 4 is fixed to a vehicle body 10 (only that part is shown in FIG. 1) in this embodiment, and does not rotate.

The hub 5 is attached to the axle 4 using two bearings 6, so as to rotate. A wheel (not shown) is attached to the outer peripheral surface of the hub 5. Also, as described previously, the transmission section 122 of the large diameter rolling element 12 is fixed to the hub 5 using bolts.

### Operation of the First Embodiment

Next, operation of the wheel drive unit of the first embodiment, and the transmission unit used with the wheel drive unit, will be described.

First, the drive source 2 is operated, and as a result the small diameter rolling element 11 is driven to rotate. With this example, as a matter of convenience, the small diameter rolling element 11 turns in a clockwise direction in FIG. 2. Obviously it is also possible for the small diameter rolling element 11 to rotate in the counterclockwise direction.

Once this is done, the large diameter rolling element 12 that is in contact with the small diameter rolling element 11 receives force from the small diameter rolling element 11 in the tangential direction (in the leftward direction in the drawing with the example of FIG. 2) and rotates. With this example, the large diameter rolling element 12 rotates in the counter clockwise direction. Further, accompanying rotation of the large diameter rolling element 12 the supplementary rolling element 13 also receives tangential force (force in a tangential direction) and rotates. With this example, the supplementary rolling element 13 rotates in the clockwise direction.

On the other hand, at the same time as the small diameter rolling element 11 and the supplementary rolling element 13 start to rotate, the pressure adjustment ring 14 also receives tangential force from the small diameter rolling element 11 and starts to rotate. In more detail, tangential force is received from the small diameter rolling element 11 in the right direction in FIG. 2, and the pressure adjustment ring 14 rotates in the clockwise direction.

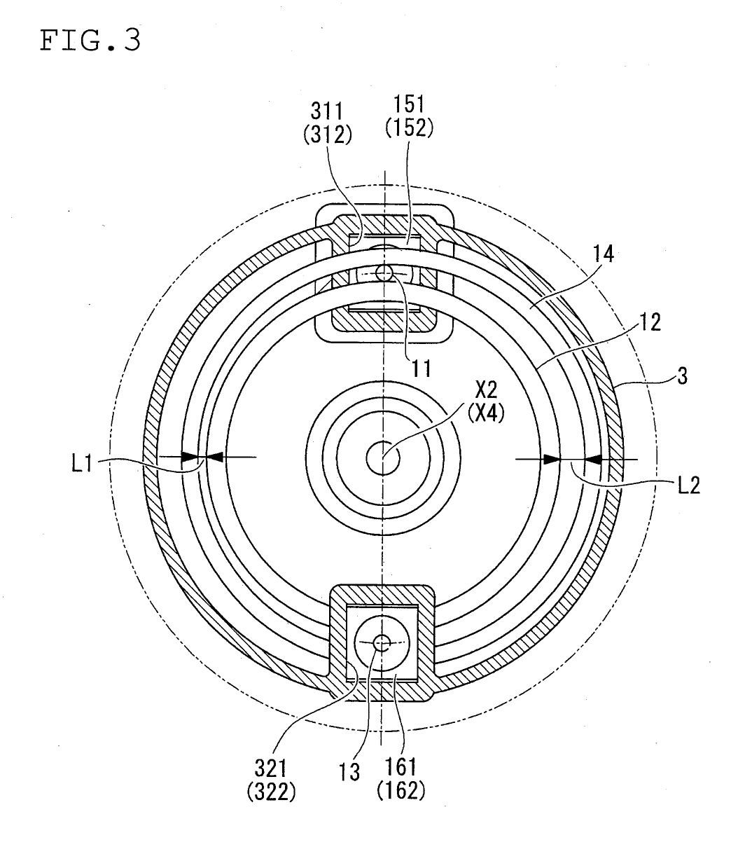

At this time, with the transmission unit of this embodiment, if the load on the large diameter rolling element 12 is raised the following phenomenon occurs. Specifically, with the small diameter rolling element 11 as a baseline, a distance L1 between the pressure adjustment ring 14 and the large diameter rolling element 12 at a rear side in the rotational direction of the pressure adjustment ring 14 (namely more to the left side than the small diameter rolling element 11 in the example of FIG. 3) is narrower than a distance L2 between them at the opposite side (refer to FIG. 3). This phenomenon arises because a tangential force due to rotation of the small diameter rolling element 11 acts on the pressure adjustment ring 14, and flexes the pressure adjustment ring 14. In more detail, this effect can be considered to be based on the following physical law. Specifically:

in a state of contact between the small diameter rolling element 11 and the pressure adjustment ring 14, tangential forces acts from the small diameter rolling element 11 on the pressure adjustment ring 14

the pressure adjustment ring 14 moves off center by d0

gaps L1 and L2 arise

and on the plane P0

\sqrt{(N/2)²−d0²}<(n1+n2+n3+d)/2

is established

the pressure adjustment ring 14 is flexed by

(n1+n2+n3+d)/2−\sqrt{(N/2)²−d0²}

stress occurs inside the pressure adjustment ring 14

and a pressing force occurs on the contact surface between the inner peripheral surface of the pressure adjustment ring 14 and the outer peripheral surface of the small diameter rolling element 14. Here, the amount of deflection of the pressure adjustment ring 14 is generally only slight.

With this embodiment, since the pressure adjustment ring 14 is supported by the small diameter rolling element 11 and the supplementary rolling element 13, the pressure adjustment ring 14 is capable of being deformed by the flexing. Also, the pressure adjustment ring 14 is capable of being made eccentric to a certain extent by this flexing. The phenomenon whereby the distance L1 is narrower than distance L2 (L1<L2) can also be described as being due to this eccentricity.

Further, at this time the small diameter rolling element 11 receives a pressing force from the pressure adjustment ring 14 towards an inner side in a radial direction of the large diameter rolling element 12 (hereafter called the “normal direction”). That is, some of the rotational force of the small diameter rolling element 11 is converted to a pressing force pressing the small diameter rolling element 11 itself in an inward direction, by means of the pressure adjustment ring 14.

Also, with this embodiment the small diameter rolling element 11 is supported by the bearings 151 and 152, but is held by the slits 311 and 312 of the support body 3 so as to be capable of movement in the radial direction of the large diameter rolling element 12. Therefore, the small diameter rolling element 11 that has received the force in the normal direction moves along the slits 311 and 312, and presses against the outer peripheral surface of the large diameter rolling element 12. With this embodiment, it is possible to increase the frictional force between the small diameter rolling element 11 and the large diameter rolling element 12 using this normal force, and it is possible to reduce slippage between the two.

However, even in the case where the slits 311 and 312 are not formed, since it is possible for the pressure adjustment ring 14 to be deformed by the flexing of itself, it is possible to exhibit the effect of improving the frictional force with the range of this flexing. In this case also therefore, it is possible to exhibit the effect of suppressing slippage between the small diameter rolling element 11 and the large diameter rolling element 12.

Here, frictional force between the small diameter rolling element 11 and the large diameter rolling element 12 is increased as load on the large diameter rolling element 12 is increased. This can be considered to be due to the fact that pressing force (force in the normal direction) on the large diameter rolling element 12 from the small diameter rolling element 11 is derived from tangential force from the small diameter rolling element 11 to the large diameter rolling element 12. For example, if load due to the large diameter rolling element 12 is increased and tangential force from the small diameter rolling element 11 to the large diameter rolling element 12 is increased, amount of eccentricity of the pressure adjustment ring 14 (amount of flexing) increases. If this happens, it can be considered that pressing force (force in the normal direction) on the small diameter rolling element 11 from the pressure adjustment ring 14 is increased, and frictional force between the small diameter rolling element 11 and the large diameter rolling element 12 is increased.

Therefore, according to this embodiment, there is the advantage that even if the load on the large diameter rolling element 12 is increased, it becomes possible to keep slippage between the small diameter rolling element 11 and the large diameter rolling element 12 low. Also, at the time of light load, since the pressing force from the small diameter rolling element 11 to the large diameter rolling element 12 is either lowered or maintained, it is possible to keep rotational resistance due to contact between the two low, and it is therefore possible to carry out high efficiency speed shifting.

Also, with this embodiment it is possible to obtain high speed-shifting ratio by using the small diameter rolling element 11 and large diameter rolling element 12. For example, if the outer diameter of the small diameter rolling element 11 is made 4 mm and the outer diameter of the large diameter rolling element 12 is made 80 mm, the speed-shifting ratio becomes 20 (=80/4). On the other hand, in the event that two gears are used in combination, if modules are taken into consideration, obtaining a high transmission gear ratio up to now has been difficult. According to this embodiment therefore, compared to the case of using toothed gears, it is made possible to reduce the size of the unit while having a high transmission gear ratio.

Further, with this embodiment, since rolling elements are used it is possible to keep the noise level low compared to the case of using toothed gears. In addition, since the unit structure is simple, it is also possible to keep cost low. There is also the advantage that assembly, fabrication and maintenance of the unit are easy.

Also, with this embodiment since the small diameter rolling element 11 that is supported at an inner side of the pressure adjustment ring 14 can move along the slit 311, the pressure adjustment ring 14 is capable of also being made eccentric in shape by movement of the small diameter rolling element 11. Accordingly, the pressure adjustment ring 14 is not only made eccentric due to flexing of itself, it is also capable of becoming eccentric accompanying movement of the small diameter rolling element 11, and in this way it is possible to pass a pressing force (force in the normal direction) to the small diameter rolling element 11. It therefore becomes possible to use a member with only slight flexing as the pressure adjustment ring 14. Also, since it is possible to increase the extent to which the pressure adjustment ring 14 is made eccentric (more accurately, the range within which eccentricity is possible determined by the dimensional tolerance d) then even in the case where the load on the large diameter rolling element 12 is increased, it is possible to impart the pressing force from the small diameter rolling element 11 to the large diameter rolling element 12 extremely reliably, and it is possible to significantly reduce slippage between the two. In the above, the fact that the possible range of eccentricity is determined by dimensional tolerance d is because when dimensional tolerance is 0, such as when tightly fitted, it can be considered that effective no eccentricity will arise. The amount of eccentricity itself is also dependent on flexing, and so is not determined solely by dimensional tolerance.

Further, with this embodiment the bearings 161 and 162 for supporting the supplementary rolling element 13 are held by the slits 321 and 322 of the support body 3 so as to be capable of movement in the radial direction of the large diameter rolling element 12. The supplementary rolling element 13 that has received the force from the pressure adjustment ring 14 to the radial direction inner side (normal direction force) can therefore move in that direction. The range in which eccentricity of the pressure adjustment ring 14 is possible is therefore further increased. In this way it becomes possible to impart the pressing force from the pressure adjustment ring 14 to the small diameter rolling element 11 extremely reliably.

Also with this embodiment, since the universal joint 17 is interposed between the small diameter rolling element 11 and the drive source 2, there is the advantage that it is easy for the small diameter rolling element 11 to move in the normal direction. However, in the case where it is possible to have only a small amount of displacement of the small diameter rolling element 11, it is possible to omit the universal joint 17, and to cause displacement utilizing flexing of the small diameter rolling element 11. Also, instead of the universal joint, it is possible to connect the small diameter rolling element 11 and the drive source 2 by means of a member which is easy to plastically deform, such as rubber, or a metal having comparatively high elasticity, for example.

If an outer section 121 of the large diameter rolling element 12 is turned by the transmission gear unit 1 of this embodiment, the hub 5 rotates with the axle 4 as a center, via the transmission section 122. In this way it is possible to cause the wheel attached to the hub 5 to rotate.

With this embodiment, the previously described first to third virtual axes of rotation X1 to X3 are arranged on a single plane, which means that there is the following advantage. Specifically, in this case, also when rotational force in the same direction as the drive direction is applied to the hub 5 (that is, for example, when the hub 5 is caused to rotate because of external force at a speed that is faster than the rotational speed due to the drive source 2, such as travelling down hill or traveling under inertia), the pressure adjustment ring 14 can be considered to not separate from the small diameter rolling element 11 within the range of the dimensional tolerance d. The reason for this is that the pressure adjustment ring 14 is supported by the small diameter rolling element 11 and the supplementary rolling element 13 that are positioned 180° apart from one another, and the pressure adjustment ring 14 is always in contact with them. In this case, therefore, slippage between the small diameter rolling element 11 and the supplementary rolling element 13 is kept low. It then becomes possible, with this embodiment, to cause braking force to act on the rotation of the wheel, using rotation resistance due to the drive source 2. Also, for example, by causing the drive source 2 to rotate in the reverse direction, it is possible to carry out a braking operation, and so it is possible to increase safety at the time of traveling.

Also, with this embodiment, each of the outer peripheral surface of the small diameter rolling element 11 and the outer peripheral surface of the large diameter rolling element 12 are made cylindrical in shape, parallel to the respective virtual axes of rotation, and the virtual axes of rotation of the small diameter rolling element 11 and the large diameter rolling element 12 are also parallel to each other. As a result, it is possible for a speed difference (spin) between the contact surfaces of the outer peripheral surface of the small diameter rolling element 11 and the outer peripheral surface of the large diameter rolling element 12 to be made zero, in principal. Accordingly, according to the unit of this embodiment, there is the advantage that it is possible to reduce rolling loss, and it is possible to improve efficiency of the transmission unit.

Further with this embodiment, each of the bearings 151, 152, 161 and 162 supporting the small diameter rolling element 11 and the supplementary rolling element 13 are capable of movement in the radial direction of the large diameter rolling element 12. With this unit, therefore, it is unlikely for these bearings 151, 152, 161 and 162 to be subjected to the effect of the pressing force due to the pressure adjustment ring 14. Accordingly, with the unit of this embodiment bearing loss due to pressing force from the pressure adjustment ring 14 is reduced, and this point also makes it possible to improve efficiency as a transmission unit.

Also, the large diameter rolling element 12 of this embodiment is formed into a hollow cylinder (refer to FIG. 1 and FIG. 2), and it is therefore possible to make the large diameter rolling element 12 light in weight. The large diameter rolling element 12 is a member that is more likely to be comparatively large within the transmission unit, so by making the large diameter rolling element 12 lightweight it is possible to make a significant contribution to reducing the weight of the transmission unit as a whole.

### Second Embodiment

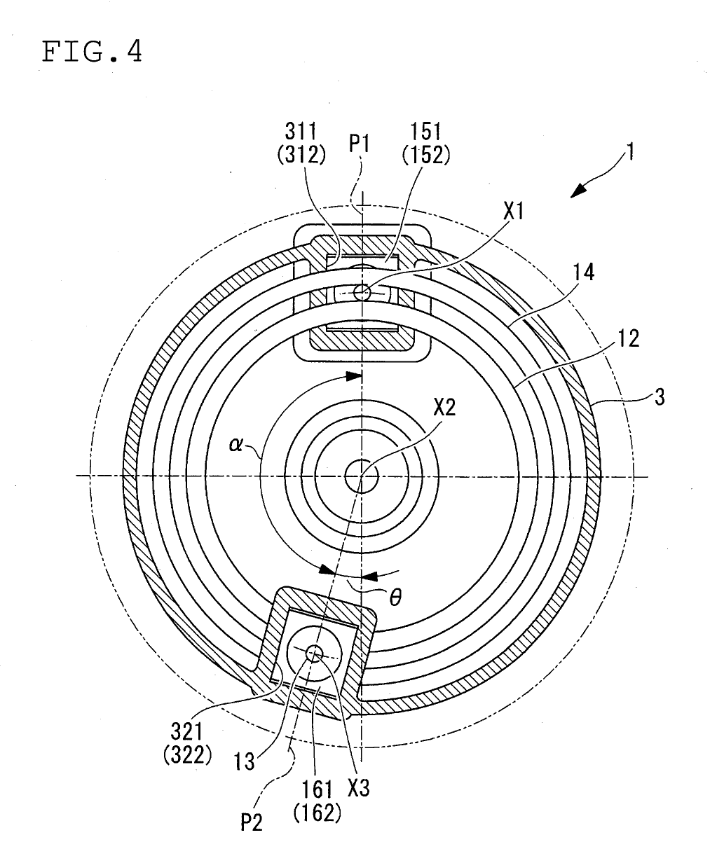

Next, a wheel drive unit using a transmission unit of a second embodiment of the present invention will be described based on FIG. 4. In the description of this embodiment, structural elements that are basically common to the first embodiment described above have the same reference numerals attached, and description will be simplified.

With the transmission unit 1 of the second embodiment, the first and second virtual axes of rotation X1 and X2 are arranged on a first virtual plane P1. On the other hand, the second and third virtual axes of rotation X2 and X3 are arranged on a second virtual plane P2.

Here, an external angle θ formed by the first plane P1 and the second plane P2 is set to 0<θ≦20 (refer to FIG. 4). Here, if internal angle is made α, then it is possible to represent the external angle θ as follows:

θ=180°−α

(refer to FIG. 4).

Specifically, with the second embodiment the position of the supplementary rolling element 13 has been moved compared to the case of the first embodiment, and as a result the third virtual axis of rotation X3 for the supplementary rolling element 13 is also moved. Further, with the movement of the supplementary rolling element 13, the positions of the bearings 161 and 162 for supporting the supplementary rolling element 13, and the slits 321 and 322, have also been moved.

In the transmission unit of the second embodiment also, if a load acts on the large diameter rolling element 12, the pressure adjustment ring 14 is made eccentric due to flexing or movement of the pressure adjustment ring 14, and the small diameter rolling element 11 is pressed against the outer peripheral surface of the large diameter rolling element 12 by this pressure adjustment ring 14.

On the other hand, with the transmission unit of the second embodiment since 0°<θ, as described previously, there is the following advantage. Specifically, in the case where rotational force in the same direction as the drive direction is applied to the hub 5 (that is, for example, when the hub 5 is caused to rotate because of external force at a speed that is faster than the rotational speed due to the drive source 2), as a result of this movement the pressure adjustment ring 14 moves in a direction to move away from the small diameter rolling element 11. The reason for this is that if the pressure adjustment ring 14 is made eccentric by a tangential force, a positional relationship between the pressure adjustment ring 14, the small diameter rolling element 11 and the supplementary rolling element 13 becomes

N≧(n1+n2+n3+d)(1+cos θ)/2

and it is no longer possible to maintain the contact state. Accordingly, in this case frictional force between the small diameter rolling element 11 and the large diameter rolling element 13 is lowered, and the large diameter rolling element 13 can slip with respect to the small diameter rolling element 11. It then becomes possible, with this embodiment, to travel under inertia. As a result efficient utilization of motive energy becomes possible, and it is possible to contribute towards energy conservation.

Also, according to this embodiment, since 0°<θ is set, in the event that the drive source 2 is stopped, there is the advantage that it is also easy to travel by hand-powering. It is therefore possible to suitably use the transmission unit of this embodiment as a transmission unit for an electrically powered wheelchair or electrically powered bicycle, for example.

On the other hand, in the case where θ≦20°, a positional relationship between the pressure adjustment ring 14, the small diameter rolling element 11 and the supplementary rolling element 13 becomes

N<(n1+n2+n3+d)(1+cos θ)/2

It is therefore possible to secure an amount of eccentricity of the pressure adjustment ring 14 in the case where there is load on the large diameter rolling element 12, and as a result pressing force from the pressure adjustment ring 14 to the small diameter rolling element 11 can be secured, which is preferable. In principle, even in a range of 20°<θ<180°, in cases where it is possible to support the pressure adjustment ring 14 it can be considered that it will be possible to demonstrate the advantage described with this second embodiment.

Remaining structure and advantages of the second embodiment are the same as the first embodiment, and so a more detailed description will be omitted.

### Third Embodiment

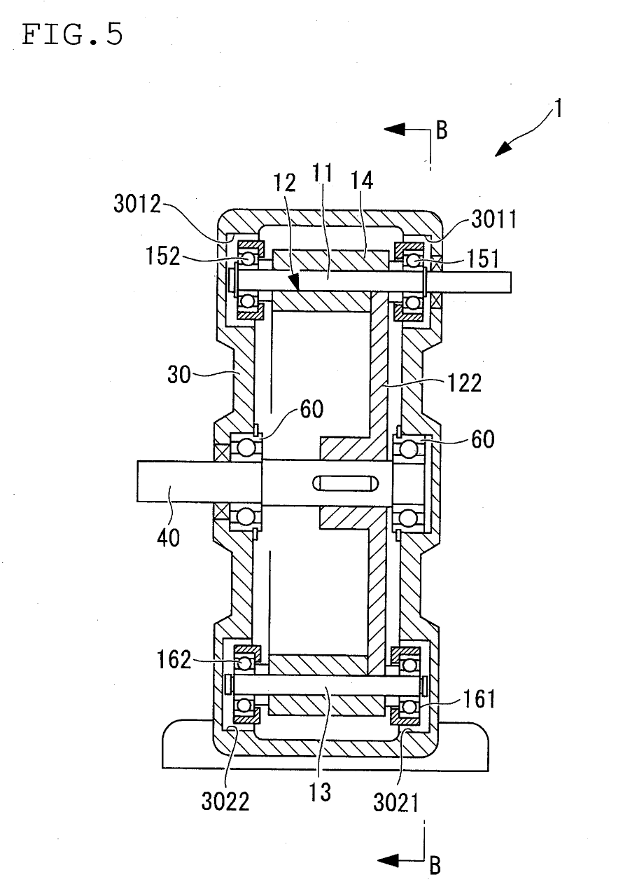

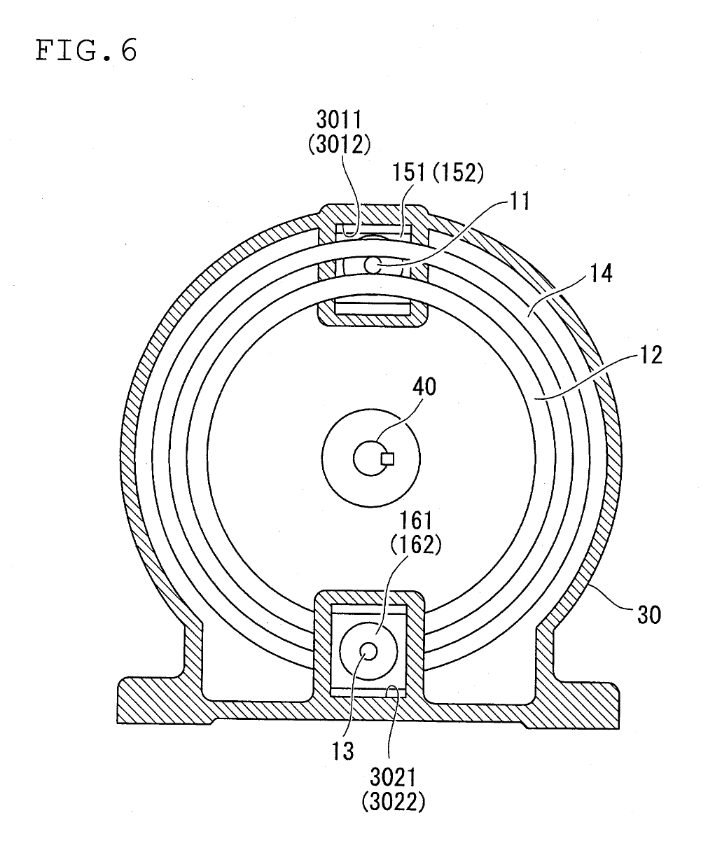

Next, a power transmission unit using a transmission unit of a third embodiment of the present invention will be described based on FIG. 5 and FIG. 6. In the description of this embodiment, structural elements that are basically common to the first embodiment described above have the same reference numerals attached, and description will be omitted.

The power transmission unit of the third invention comprises a transmission unit 1, a casing 30, an output shaft 40, and two bearings 60.

A transmission section 122 of the transmission unit 1 of the third embodiment is fixed to the output shaft 40. The output shaft 40 is rotatably attached to the casing 30 by means of the bearings 60.

Also, the casing 30, similarly to the first embodiment, is provided with slits 3011 and 3012 for attachment of the bearings 151 and 152 for the small diameter rolling element 11, and slits 3021 and 3022 for attachment of the bearings 161 and 162 for the supplementary rolling element 13. Using these slits, the small diameter rolling element 11 and supplementary rolling element 13 become capable of movement along the radial direction of the large diameter rolling element 12.

The small diameter rolling element 11 of the third embodiment is connected to an appropriate rotational drive mechanism (not shown), so as to be rotatably driven. If the small diameter rolling element 11 rotates, then the large diameter rolling element 12 rotates as a result of the operation described in the first embodiment. This drive force is transmitted via the transmission section 122 to the output shaft 40, and the output shaft 40 is rotatably driven.

In the previous description, the transmission unit 1 was described as a speed-reduction mechanism, but in theory it can also be used as a speed-up mechanism. Specifically, in theory it is possible to add rotational force as input from the output shaft 40, and for the small diameter rolling element 11 to be speeded up by this rotational force, and driven to rotate. In the case of speeding-up also, from similar theory to that already described, it is possible for the small diameter rolling element 11 to press against the large diameter rolling element 12 due to the operation of the pressure adjustment ring 14, and it is possible to increase frictional force between the two.

In the third embodiment also, similarly to the second embodiment, by varying the position of the supplementary rolling element 13 it is possible to perform slipping of the small diameter rolling element 11.

Remaining structure and advantages of the third embodiment are the same as the first embodiment, and so a more detailed description will be omitted.

### Fourth Embodiment

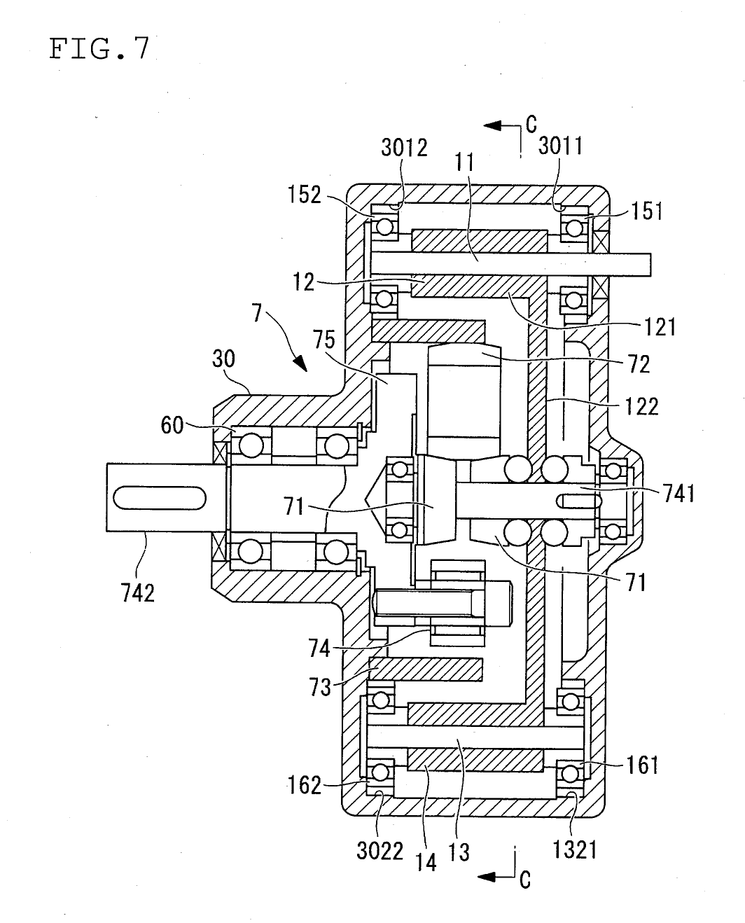

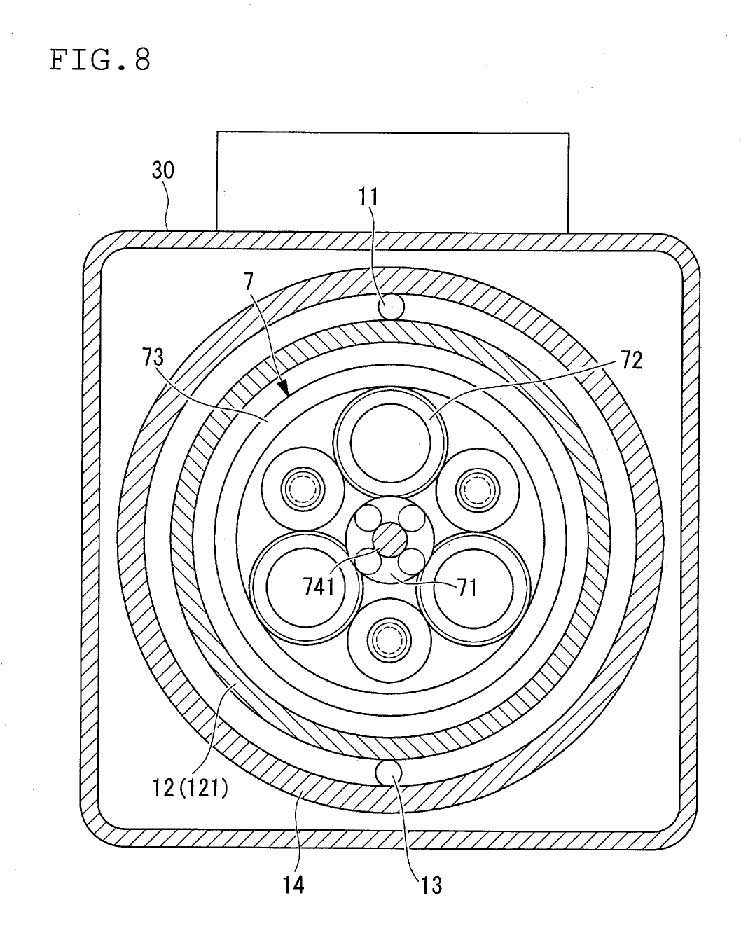

Next, a power transmission unit using a transmission unit 1 of a fourth embodiment of the present invention will be described based on FIG. 7 and FIG. 8. In the description of this embodiment, structural elements that are basically common to the third embodiment described above have the same reference numerals attached, and description will be simplified.

The power transmission unit of the fourth embodiment is basically the unit of the third embodiment, further provided with a speed-reduction mechanism 7 housed inside the large diameter rolling element 12. Also, the transmission section 122 of the large diameter rolling element 12 is connected to an intermediate shaft 741. With the fourth embodiment, rotational force of this intermediate shaft 741 is speeded-down by the speed-reduction mechanism 7, and output to an output shaft 742. By definition, with power transmission units it is generally not necessary to directly connect the transmission section 122 and the intermediate shaft 741, but it is possible to have a member interposed between them.

With the reduction gear mechanism 7, rotation that has been imparted to the intermediate shaft 741 is transmitted to a sun roller 71. A planetary roller 72 then revolves and thus turns at the inner peripheral surface of a ring 73. Revolution of the planetary roller 72 is transmitted to the output shaft 742 via a bearing 74 and a carrier 75 to which the bearing 74 is fixed.

According to the fourth embodiment, using the speed-reduction mechanism 7 it becomes possible to obtain a still larger speed reduction ratio (or speed-up ratio). Further, with this embodiment, since the speed-reduction mechanism is housed inside the large diameter rolling element 12, there is the advantage that it is possible to reduce the size of the unit.

Remaining structure and advantages of the fourth embodiment are the same as the first embodiment, and so a more detailed description will be omitted. A planetary roller mechanism has been used as the speed-reduction mechanism 7 of the fourth embodiment, but instead it is also possible to use a planetary gear mechanism.

The transmission unit of the present invention, and the wheel drive unit and the power transmission unit using this transmission unit, are not limited to the above described embodiments, and various modifications can additionally be obtained within a scope that does not depart from the spirit of the invention.

For example, with the illustrated examples the diameters of the small diameter rolling element and the supplementary rolling element are almost equal, but in theory they do not have to be equal.

Also, the material for the members small diameter rolling element 11, large diameter rolling element 12, supplementary rolling element 13 and pressure adjustment ring 14 is not particularly limited. Preferably a material that has strong abrasion resistance and has a certain frictional force is used. For example, as a material for these members there are metal or ceramics. Regardless of what material is used, since it can be considered that minute flexing will occur, it is also possible to use a hard material as the pressure adjustment ring 14. In the case where the amount of flexing is insufficient also, by using the slits that have been described above, it is possible to demonstrate the pressure adjusting effect.

Also, with each of the above described embodiments, due to each of the slits it was possible for the small diameter rolling element 11 and the supplementary rolling element 13 to move in the radial direction of the large diameter rolling element 12. However, it is also possible for the extending direction of the slits to be inclined with respect to the radial direction of the large diameter rolling element 12. Basically, it is sufficient as long as the small diameter rolling element 11 and the supplementary rolling element 13 can be displaced in a radial component direction of the large diameter rolling element 12.

Also, after machining components in a small range of dimensional tolerance d, if these components are assembled in a state tightly fitted together, it is possible to generate a pressing force even if the pressure adjustment ring 14 is not made eccentric. In this case, it is possible to provide a plurality of supplementary rolling elements 13. The supplementary rolling elements 13 in this case play the part of balls or rollers of a general bearing, and contribute to positioning of the pressure adjustment ring 14, and improvement in transmission performance.

Also, although it is possible to have direct contact between the outer peripheral surface of the small diameter rolling element 11 and the outer peripheral surface of the large diameter rolling element 12, in order to avoid surface damage it is preferable to interpose traction oil or traction grease between the two. In this case an oil film exists between the outer peripheral surface of the small diameter rolling element 11 and the outer peripheral surface of the large diameter rolling element 12, under high pressure acting between the two. The small diameter rolling element 11 and the large diameter rolling element 12 can transmit one rotational force to another rotational force as a result of utilizing a tangential force in the oil film as a shear force.

1. A transmission unit, comprising a small diameter rolling element, a large diameter rolling element, a supplementary rolling element, and a pressure adjustment ring, wherein
the small diameter rolling element is capable of rotation with a first virtual axis of rotation as a center, and
an outer peripheral surface of the small diameter rolling element is brought into contact with an outer peripheral surface of the large diameter rolling element,
the large diameter rolling element is capable of rotation with a second virtual axis of rotation as a center, and
the second virtual axis of rotation of the large diameter rolling element is arranged so as to be substantially parallel to the first virtual axis of rotation of the small diameter rolling element,
the supplementary rolling element is capable of rotation with a third virtual axis of rotation as a center, and
an outer peripheral surface of the supplementary rolling element is brought into contact with an outer peripheral surface of the large diameter rolling element, and further
the third virtual axis of rotation of the supplementary rolling element is arranged so as to be substantially parallel to the first virtual axis of rotation of the small diameter rolling element, and
the supplementary rolling element is arranged at a position that sandwiches the large diameter rolling element with the small diameter rolling element,
the pressure adjustment ring is arranged so as to surround the small diameter rolling element, the large diameter rolling element and the supplementary rolling element, and
the pressure adjustment ring is also capable of rotation with a fourth virtual axis of rotation as a center, and also
the fourth virtual axis of rotation of the pressure adjustment ring is arranged so as to be substantially parallel to the second virtual axis of rotation of the large diameter rolling element, and
an inner peripheral surface of the pressure adjustment ring is brought into contact with the outer peripheral surface of the small diameter rolling element and the outer peripheral surface of the supplementary rolling element.

2. The transmission unit as disclosed in claim 1, wherein the small diameter rolling element is capable of movement in a radial direction of the large diameter rolling element.

3. The transmission unit as disclosed in claim 1, wherein the supplementary rolling element is capable of movement in a radial direction of the large diameter rolling element.

4. The transmission unit as disclosed in claim 1, wherein the pressure adjustment ring is supported by the small diameter rolling element and the supplementary rolling element.

5. The transmission unit as disclosed in claim 1, wherein the first to third virtual axes of rotation are arranged on a single plane.

6. The transmission unit as disclosed in claim 1, wherein
the first and second virtual axes of rotation are arranged on a first plane,
the second and third virtual axes of rotation are arranged on a second plane, and
an external angle θ defined by the first plane and the second plane is 0<θ<180°.

7. The transmission unit of claim 1, further comprising a speed-reduction mechanism, and wherein
the speed reduction mechanism is arranged at an inner side of the large diameter rolling element, and
the speed reduction mechanism has a structure that reduces speed of rotational force applied to the large diameter rolling element as a result of being connected to the large diameter rolling element.

8. The transmission unit of claim 1, wherein the small diameter rolling element of the present invention is capable of connection to a drive source for driving the small diameter rolling element in a direction in which the small diameter rolling element rotates.

9. A wheel drive unit, provided with the transmission unit of claim 1, an axle, and a wheel support section, wherein
the wheel support section is capable of rotation with respect to the axle, and
the wheel support section is connected to the large diameter rolling element, and rotates in accordance with rotation of the large diameter rolling element.

10. A power transmission unit, provided with the transmission unit of claim 1, and an output shaft, wherein
the output shaft is connected to the large diameter rolling element, and rotates in accordance with rotation of the large diameter rolling element.

11. The transmission unit of claim 1, wherein the outer peripheral surface of the small diameter rolling element and the outer peripheral surface of the large diameter rolling element utilize as a frictional force a shear force of an oil film of traction oil or traction grease under high pressure between these two surfaces so that a rotational force on either of the surfaces can be transmitted to another surface.
